(19) United States
(12) Patent Application Publication
(10) Pub. No.: US 2005/0278293 A1
(43) Pub. Date: Dec. 15, 2005

(54) Document retrieval system, search server, and search client

(75) Inventors: Osamu Imaichi, Wako (JP); Hiroko Ohi, Kokubunji (JP); Yoshiki Niwa, Hatoyama (JP)

Correspondence Address: Stanley P. Fisher;Reed Smith LLP, Suite 1400, 3110 Fairview Park Drive, Falls Church, VA, 22042-4503, US

(73) Assignee: Hitachi, Ltd.

(21) Appl. No.: 11/036,335

(22) Filed: Jan. 18, 2005

(30) Foreign Application Priority Data
Jun. 11, 2004 (JP) 2004-174363

(51) Int. Cl. G06F 7/00

(52) U.S. Cl. 707/1

(57) ABSTRACT

To provide a summary of a search result in an associative search system based on multiple viewpoints. By indexing one document database in plural ways, a summary of a search result can be displayed from multiple viewpoints. By managing documents in indexed versions of the document database by common identifiers, summaries of a document set obtained as a search result can be created using the different indexes.

### CLAIM OF PRIORITY

The present application claims priority from Japanese application JP 2004-174363 filed on Jun. 11, 2004, the content of which is hereby incorporated by reference into this application.

### FIELD OF THE INVENTION

The present invention relates to a document retrieval system, and more particularly to an associative search system that displays a summary of a search result from multiple viewpoints.

### BACKGROUND OF THE INVENTION

With the widespread use of computers and the Internet, the electronization of document information is advancing rapidly. As accessible information increases, locating necessary information from it is becoming an important theme. Moreover, there is an increasing demand to examine the relevance levels of documents among plural document databases. For example, there is a growing demand to search for encyclopedia items related to interesting newspaper articles.

With keyword search presently in practical use, plural document databases can be switched for search, but a document set related to a document set contained in a given document database cannot be retrieved from the identical document database or other document databases (a search method called document associative search).

Within an identical document database, relevance levels among documents have only to be calculated in advance to implement the document associative search with a document set as search input. However, for plural document databases, since the relevance levels among documents to be calculated in advance increases explosively in the number of combinations as the number of document databases increases, the document associative search is practically impossible.

In contrast to this, in JP-A No. 155758/2000 “Document Retrieval Method and Document retrieval Service for Plural Document Databases,” a method is disclosed which efficiently retrieves a document set related to a document set in a user-specified document database from arbitrary document databases. This method achieves rapid document associative search by using only characteristic words within search input inputted as a document set. This method enables the user to perform accurate and efficient document retrieval by examining relevance levels of document sets while switching among different types of plural document databases. This method also aids the user in determining whether a search result is satisfactory, by extracting characteristic words occurring in a document set obtained as the search result and presenting them to the user as a summary of the search result. [Patent document 1] JP-A No. 155758/2000

### SUMMARY OF THE INVENTION

To achieve document retrieval based on words, documents are indexed by words occurring in the documents. The same is also true for the method disclosed in JP-A No. 155758/2000. To extract characteristic words from a document, for words contained in the document, their importance is calculated using statistical measures (e.g., the tf*idf method) so that the words are extracted in descending order of importance. It is general to make one index for one document database. However, technical terms (disease name, gene name, and protein name, etc. in the biomedicine field) and fact information (protein-protein interaction, etc. in the biomedicine field, for example) are difficult to extract as characteristic words because they will be buried in a general word distribution. Since only one index displays a summary limited to one viewpoint as a search result, the summary display may not be satisfactory when the viewpoint does not match the user's query and interest.

The present invention has been made in view of the above circumstances and provides a document retrieval system that provides a summary display of a search result from multiple viewpoints matching user's interest.

To solve the above-mentioned problem, the present invention indexes one document database in plural ways to enable a summary display of a search result from multiple viewpoints.

For example, one document database is indexed by ordinary words, technical terms, and fact information. To establish correspondences among the indexed versions of the document database, individual documents are managed by common identifiers so that a summary of a given document can be created using the different indexes.

A document retrieval system of the present invention includes a search client having: an input part that inputs queries; a part for showing search result that displays searched document sets; and a part for showing topic words that displays summaries of the searched document sets, and a search server having: a document database that stores indexed plural documents; a part for search that retrieves, in response to a received query, highly related documents from the document database; and a part for summarization by extracting topic words that creates, for a given document set, a summary using the indexes, wherein plural different types of indexes are provided as the indexes.

The part for showing topic words of the search client displays plural types of summaries correspondingly to different viewpoints. The part for showing search result includes a part for selecting documents that selects the documents to become keys to a next search from a displayed document set, and the part for showing topic words includes a part for selecting topic words that selects the elements to become keys to a next search from elements of a displayed summary.

By viewing summaries from multiple viewpoints for a document set obtained as a search result, the user can grasp the nature of the search result more appropriately. Moreover, since relations among the viewpoints can be grasped through the documents subject to retrieval, the search result can be analyzed in more detail.

### BRIEF DESCRIPTION OF THE DRAWINGS

FIG. 1 is a schematic diagram showing the configuration of a system for implementing the present invention;

FIG. 2 is a drawing showing an example of an initial screen in a search client;

FIG. 3 is a drawing showing an example of a search result in a search client;

FIG. 4 shows an example of indexing;

FIG. 5 shows an example of indexing;

FIG. 6 shows an example of indexing;

FIG. 7 is a sequence diagram showing the flow of data and processing among a search client, an associative search server, and search servers;

FIG. 8 is a sequence diagram showing the flow of data and processing among a search client, an associative search server, and search servers;

FIG. 9 is a drawing showing a display example of a search result in a search client;

FIG. 10 is a drawing showing an initial screen in a search client; and

FIG. 11 is a schematic diagram showing another configuration of the system for implementing the present invention.

### DETAILED DESCRIPTION OF THE PREFERRED EMBODIMENTS

Hereinafter, embodiments of the present invention will be described in detail with reference to the drawings.

### First Embodiment

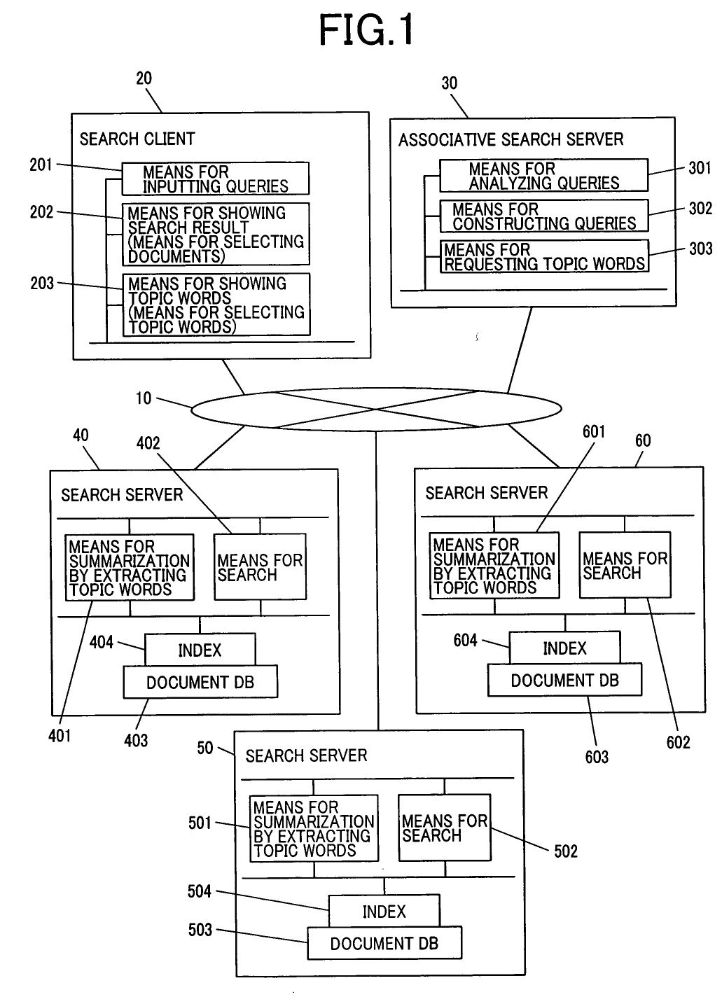

FIG. 1 is a schematic diagram showing the configuration of a system for implementing the present invention. This system comprises: a search client 20 by which a user inputs queries, and displays search result; search servers 40, 50, and 60 for searching document databases; an associative search server 30 that mediates between a search client 20, and the search servers 40, 50, and 60. The search client and these servers are connected over a communication network 10. In an example shown in the drawing, three search servers are connected to the communication network as search servers for searching document databases. However, any number of search servers may be connected to the communication network. The number of search clients is also arbitrary.

The respective means for search 402, 502, and 602 of the search servers 40, 50, and 60 retrieves, in response to a query sent from the associative search server, highly related document sets from the document databases 403, 503, and 603, and returns a search result with weighted relevance levels to the associative search server 30. The means for search can be implemented by known keyword search methods.

The keyword search method splits, to increase the efficiency of search processing, a document contained in a document database into words (performs morphological analysis for Japanese documents and stemming processing for English documents), and creates indexes to indicate what words are contained in what documents. During search execution, since the created indexes are read into main storage, the search processing can be performed at high speed. In FIG. 1, indexes 404, 504, and 604 are created for the respective document databases 403, 503, and 603 of the search servers 40, 50, and 60, and are used for the search processing.

The respective means for summarization by extracting topic words 401, 501, and 601 of the search servers 40, 50, and 60 create a summary of a document set retrieved from the document databases 403, 503, and 603. The summary here refers to a set of words indicating the contents of the document set. As the means for summarization by extracting topic words, existing methods disclosed in JP-A No. 155758/2000 are available. The above-mentioned indexes are also used to create summaries. That is, what words are contained in a given document is determined by referring to the indexes.

As an example, the frequencies of words contained in all documents in a document group whose summary is to be created are counted. Generally, since words occurring more frequently in a document set are more representative of the document set, they are more likely to be contained in a summary. However, common words such as “SURU (perform)” that occur frequently in any documents are not suitable as topic words. Therefore, usually, topic words are selected also in consideration of the occurrences of the words in a document database to which the document set belongs. Specifically, words that occur more frequently in a specified document set and occur less frequently in the whole document database are more characteristic words and more suitable as topic words characterizing the document set because they occur conspicuously only in the document set. To be more specific, individual words in the document set are calculated by a proper function with occurrence frequency in the document set and occurrence frequency in the document database as input, and words having a weight of a given threshold or greater are adopted as topic words.

The search client 20 includes means for inputting query 201, means for showing search result 202, and means for showing topic words 203.

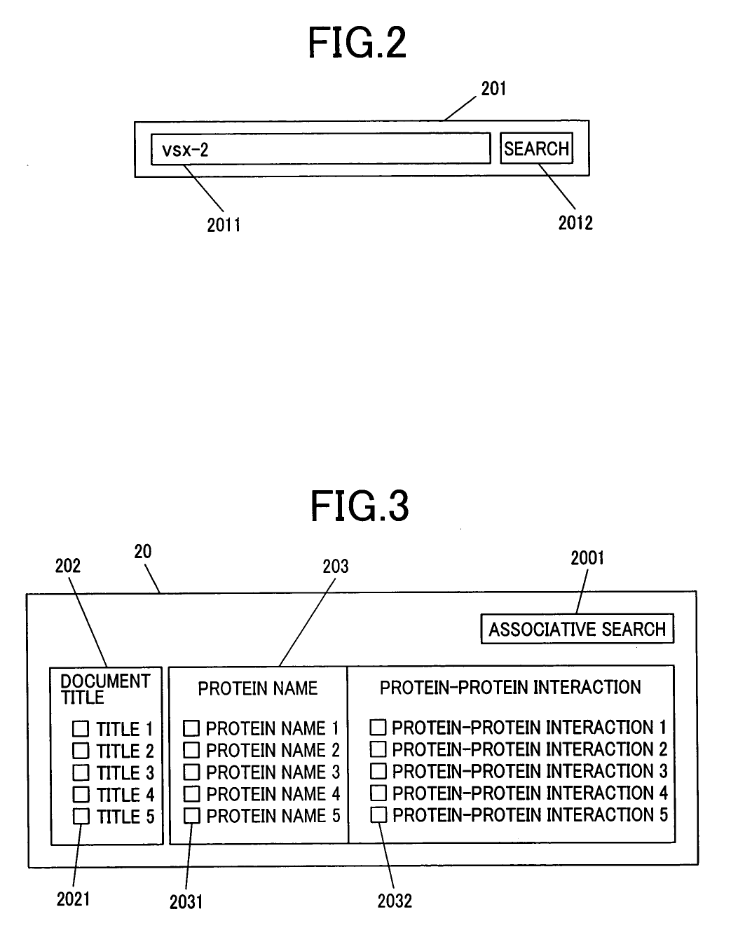

FIG. 2 is a drawing showing an example of an initial screen in the search client. The user performs a search by inputting a query to a query input area 2011, and clicking a search command button 2012.

FIG. 3 is a drawing showing an example of a search result in the search client. The search result is displayed by the means for showing search result 202, and a summary of the search result is displayed by the means for showing topic words 203. The means for showing search result 202 also serves as means for selecting document sets. When any number of documents are selected by document selection check boxes 2021 and an associative search command button 2001 is clicked, the means for showing search result 202 searches for documents related with the selected documents. The means for showing topic words 203 also serves as means for selecting topic words. When any number of words are selected by word selection check boxes 2031 and 2032 and the associative search command button 2001 is clicked, the means for showing topic words 203 performs a search from the topic words.

The associative search server 30 includes: means for analyzing queries 301 that analyzes queries sent from the search client 20; means for constructing queries 302 that distributes queries sent from the search client 20 to the search servers 40, 50, and 60; and means for requesting topic words 303 that request topic words for document sets to the search servers 40, 50, and 60.

The means for analyzing queries 301 analyzes a query sent from the search client 20 and identifies words contained in it to create a search key. The means for analyzing queries 301 includes at least a morphological analysis process of splitting sentences into words for Japanese text, and a stemming process of reconstituting words into their original forms and attaching parts of speech for English text.

A query sent to the means for constructing queries 302 is: (1) a word set created by the means for analyzing queries 301; (2) a set of document IDs sent from the means for showing search result (means for selecting document sets) included in the search client 20; or (3) a word set sent from the means for showing topic words 203 (means for selecting topic words) included in the search client 20. When a query is (1) or (3), the word set is sent to the search server as the query. When a query is (2), the means for requesting topic words 303 requests a summary of a document set corresponding to the set of document IDs to the search server, and sends a received topic word set to a search server as the query. To which search server the means for constructing queries 302 sends a query depends on the contents of indexes the search servers hold; its operation will be described using an example described later.

In conventional associative search systems, one document database has been indexed only from one viewpoint. The present invention intends to increase user convenience by indexing one document database from multiple viewpoints. Requirements for achieving this are (1) creating an index from multiple viewpoints, and (2) managing identical documents contained in plural indexed document database by common identifiers. By managing the identical documents by the common identifiers, identification can be held between the respective indexes of document sets obtained as search result. Therefore, topic words can be created for identical document sets from different viewpoints.

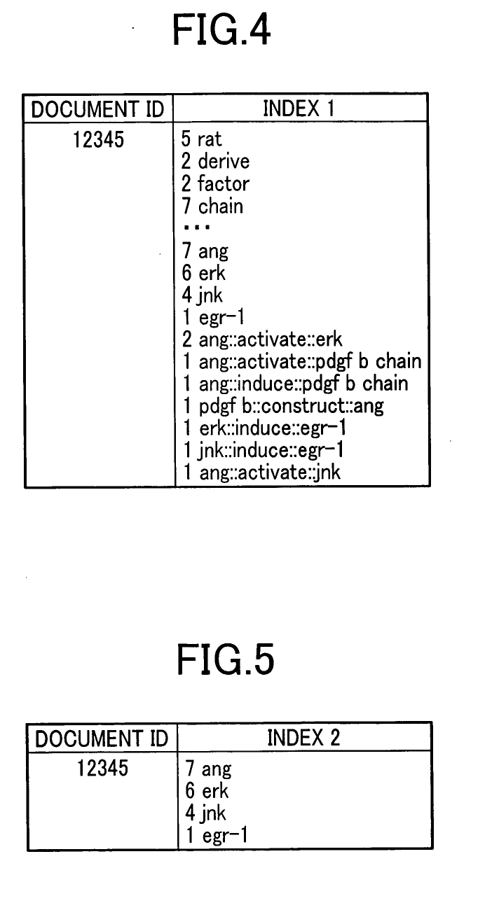

FIGS. 4, 5, and 6 show examples of indexes when one document database is indexed from multiple viewpoints.

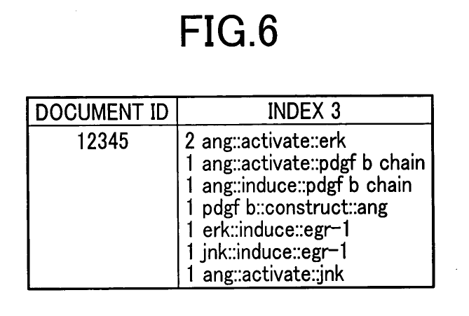

FIG. 4 shows an example of indexing a document having a document ID of 12345 by general words, protein names, and protein-protein interaction. A number preceding each word in the index column designates the occurrence frequency of the word in the document. FIG. 5 shows an example of indexing a document having a document ID of 12345 by protein names. FIG. 6 shows an example of indexing a document having a document ID of 12345 by protein-protein interaction. The common document ID “12345” is used in different indexes to satisfy the above-mentioned requirements (2). Although a method of creating indexes from different viewpoints is arbitrary, practically, it is convenient to create indexes so that one index contains other plural indexes. In the above-mentioned example, the index of FIG. 4 contains the indexes of FIGS. 5 and 6. By doing so, all queries sent to the above-mentioned means for constructing queries 302 may be sent to the search server 40. The search servers 50 and 60 are used only when a summary of a search result is created.

FIG. 3 is a drawing showing an example of an associative search by use of the indexes of FIGS. 4, 5, and 6. Titles are displayed as a search result. As a summary of the search result, protein names and protein-protein interactions contained in the titles are displayed.

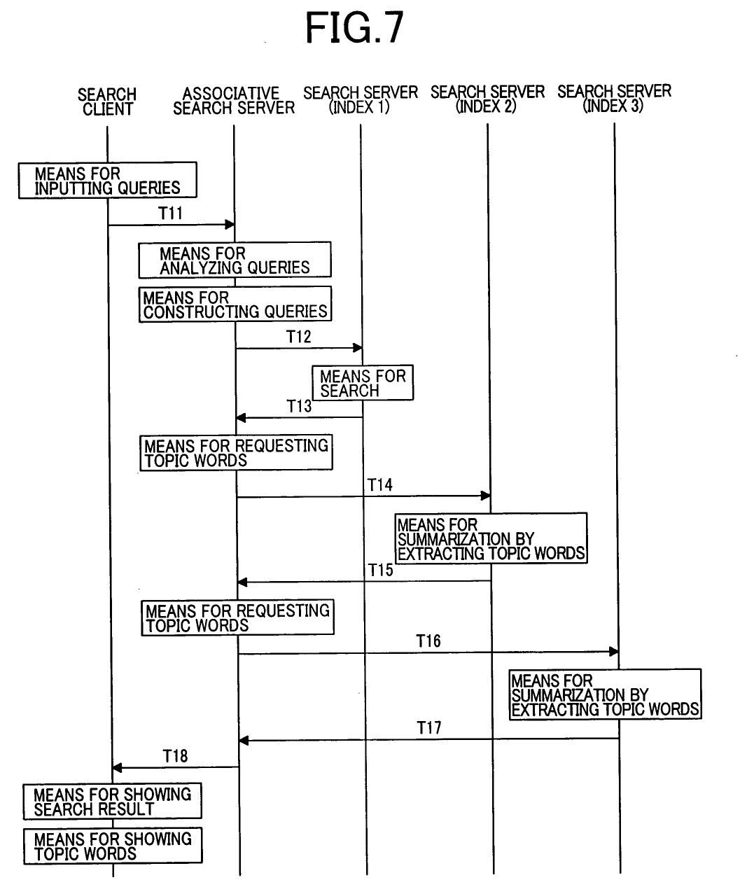

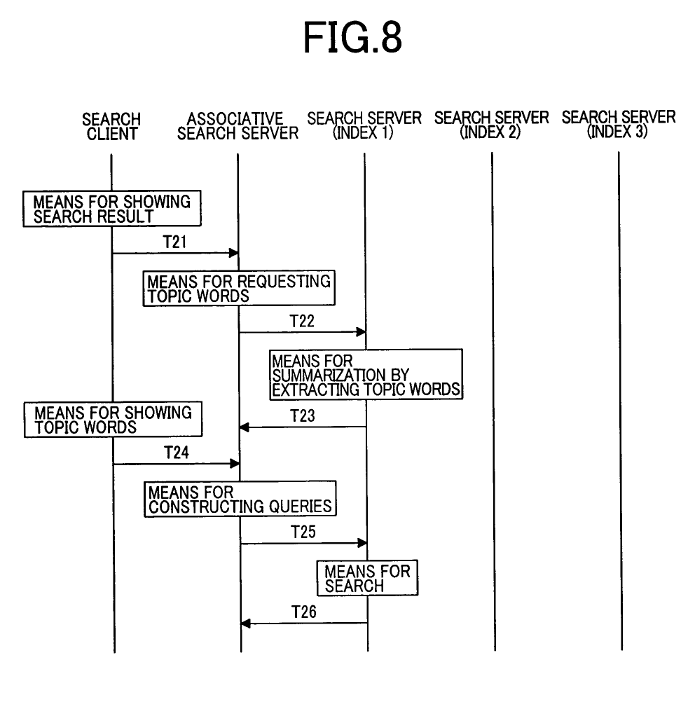

Hereinafter, the flow of processing will be described using sequence diagrams of FIGS. 7 and 8. For convenience of description, the indexes 404, 504, and 604 of the document databases 403, 503, and 603 included in the search servers 40, 50, and 60 are created as shown in FIGS. 4, 5, and 6. When such indexing has been performed, the operation of the means for constructing queries 302 is performed as described below. For a user-inputted query, the means for constructing queries 302 issues the query to the search server 40. When topic words are created for a search result obtained from the search server 40, the means for requesting topic words 303 issues a request to create topic words to the search servers 50 and 60. When the user specifies a document set to execute a re-search from the document set, the query is issued to the search server 40. In this way, all searches are performed in the search server 40. The search servers 50 and 60 are used only to create topic words of a search result. Even if words of both “Protein name” and “Protein-protein interaction” are specified, the search server 40 operates without problem because it has indexes of the search servers 50 and 60.

The following describes the flow of processing with reference to the sequence diagram of FIG. 7. The user inputs a query using the means for inputting query 201 of the search client 20. The inputted query is transmitted to the associative search server (T11). The means for analyzing queries 301 of the associative search server 30 analyzes the query, and creates a query for transmission to a search server. The query is transmitted to the search server 40 by the means for constructing queries 302 (T12). Means for search 402 of the search server 40 searches the document database 403 using the index 404, and transmits the result to the associative search server 30 (T13). The means for requesting topic words 303 of the associative search server 30 transmits, to create a summary of the obtained search result, a request to create the summary to the search servers 50 and server 60 (T14, T16). The means for summarization by extracting topic words 501 and 601 of the search servers 50 and 60 create topic words by using the indexes 504 and 604, respectively. In the case of this example, the means for summarization by extracting topic words 501 creates topic words composed of protein names, and the means for summarization by extracting topic words 601 creates topic words composed of protein-protein interactions. The topic words created by the respective means for summarization by extracting topic words are transmitted to the associative search server 30 (T15, T17). Finally, the search result and the topic words are transmitted from the associative search server 30 to the search client 20 (T18), and are presented to the user by the means for showing search result 202 and the means for showing topic words 203 of the search client 20.

A sequence diagram of FIG. 8 is used for the following description. The sequence diagram shows the flow of processing in the case of performing re-search from documents and topic words obtained as a search result.

First, the case of performing a re-search from documents obtained as a search result is described. The user selects the documents to become keys to the re-search by using the means for selecting documents 202 of the search client 20. The identifiers of selected documents are transmitted to the associative search server 30 (T21). The means for requesting topic words 303 of the associative search server 30 transmits, to create a summary of the selected document, a request to create the summary to the search server 40 (T22). The means for summarization by extracting topic words 401 of the search server 40 creates topic words using the index 404. Specifically, as described previously, it statistically selects important words by the same method as described in JP-A No. 155758/2000 to create topic words. The created topic words are transmitted to the associative search server 30 (T23).

When the user executes a re-search only from documents, obtained topic words are transmitted to the search server 40 by the means for constructing queries 302 of the associative search server 30 (T25). The means for search 402 of the search server 40 searches the document database 403 by using the index 404, and transmits the result to the associative search server 30 (T26). Subsequent processing is the same as processing after the means for summarization by extracting topic words in the sequence diagram of FIG. 7.

When performing a re-search from topic words, the user selects the words to become keys to the re-search by using the means for selecting topic words 203 of the search client 20. At this time, words of multiple viewpoints may be specified at the same time. Selected words or word identifiers are transmitted to the associative search server 30 (T24). Subsequent processing is the same as processing after the means for constructing queries in the sequence diagram of FIG. 8.

By performing a re-search by using topic words created from a certain viewpoint, the relation between the viewpoint and other viewpoints can be grasped through document databases. As an example, when a re-search is performed using topic words composed of protein names, documents related to the selected protein names are obtained, and moreover, protein name interactions related to the selected protein names can be obtained. This enables a detailed analysis of search result from different viewpoints.

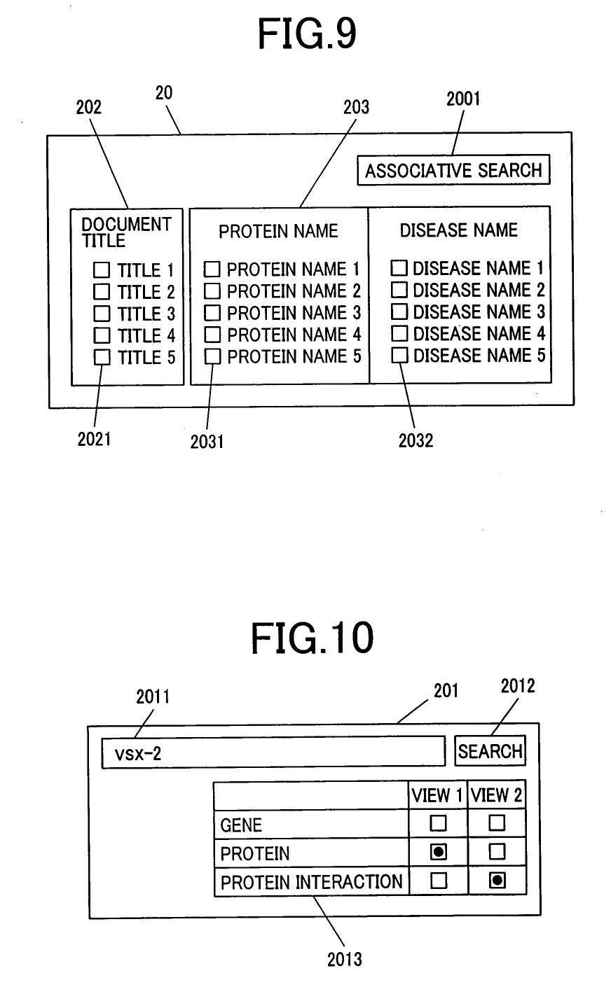

FIG. 9 shows an example of using protein names and disease names as index. By using the same procedure as described above, from protein names interesting to the user, disease names related to the protein names can be determined. Conversely, from disease names interesting to the user, protein names related to the disease names can be determined.

### Second Embodiment

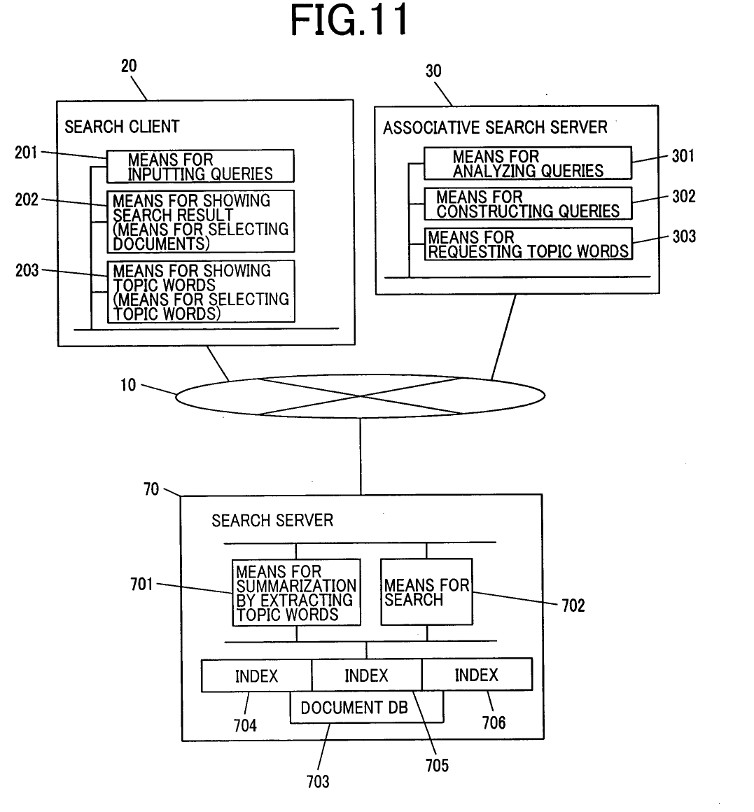

The following describes a variant of the present invention with reference to FIG. 10.

In the first embodiment, from which viewpoint a summary of a search result is to be created is fixed in advance. However, plural search servers to hold indexes from multiple viewpoints may be provided in advance so that the user can select a desirable viewpoint to be used. FIG. 10 shows an example of an initial screen from which the user selects a viewpoint.

Means for selecting viewpoints 2013, presents, as viewpoints (view1, view2), three selectable viewpoints (index by “gene”, index by “protein”, and “protein interaction.”) The user selects a viewpoint from which a summary is to be obtained. In an example of FIG. 10, the user selects index by “protein” as view1, and “protein interaction” as view2.

After this, the user inputs a query to a query input area 2011 and clicks a search command button 2012 to perform a search. Subsequent processing is the same as that in the first embodiment.

### Third Embodiment

The following describes a variant of the present invention with reference to FIG. 11.

In the first embodiment, different servers hold indexes having been created from multiple viewpoints. Specifically, the index of FIG. 4, the index of FIG. 5, and the index of FIG. 6 are held by the index 404 of the search server 40, the index 504 of the search server 50, and the index 604 of the search server 60, respectively. However, plural search servers are not always required; one search server may hold plural indexes.

FIG. 11 is a block diagram when one search server holds plural indexes. Indexes created from multiple viewpoints with respect to a document database 703 of the search server 70 are held as indexes 704, 705, and 706. When plural indexes are held in one search server, generally the indexes are held independently. The individual indexes can be organized into a matrix with documents in a column axis and words in a row axis, for example. Elements of the matrix contain occurrence frequency information indicating how many times a particular word occurs in a particular document. In this case, since the identification of documents in the column axis must be maintained among plural indexes (matrixes), identical documents are managed by identical identifiers among the plural indexes.

In the first embodiment, the means for constructing queries 302 of the associative search server 30 controls to which search server a query is to be issued according to the type of the query. As shown in FIG. 11, in the case where the number of search servers is one, the means for constructing queries 302 may control which index of the search server 70 to use for a search according to the type of the query. In the sequence diagrams of FIGS. 7 and 8, by regarding all the search servers as identical search servers, the same processing as in the first embodiment is performed.

1. A document retrieval system including:
a search client having: an input part that inputs queries; a part for showing search result that displays searched document sets; and a part for showing topic words that displays summaries of the searched document sets, and
a search server having: a document database that stores indexed plural documents; a part for search that retrieves, in response to a received query, highly related documents from the document database; and a part for summarization by extracting topic words that creates, for a given document set, a summary using the indexes,
wherein plural different types of indexes are provided as the indexes.

2. The document retrieval system according to claim 1, including plural search servers, wherein the search servers respectively include different types of indexes, and identical documents are managed by identical identifiers among document databases of the plural search servers.

3. The document retrieval system according to claim 1, wherein one search server includes the plural different types of indexes, and identical documents are managed by identical identifiers among the plural indexes.

4. The document retrieval system according to claim 1, wherein one of the plural indexes is an integration of remaining plural indexes.

5. The document retrieval system according to claim 1, wherein the part for showing topic words of the search client includes an index-specific part for showing topic words that displays different summaries correspondingly to different indexes.

6. The document retrieval system according to claim 5, wherein the search client includes means for selecting elements of a summary displayed in the part for showing topic words, and transmits the selected elements as the query.

7. A search server including:
a document database that stores plural documents;
plural types of indexes provided for documents in the document database from different viewpoints;
a search part that retrieves, in response to a received query, highly related documents from the document database; and
a part for summarization by extracting topic words that creates, for a given document set, plural types of summaries by using the indexes,
wherein identical documents are managed by identical identifiers among the plural indexes.

8. A search client including:
an input part that inputs queries;
a part for showing search result that displays a document set as a received search result; and
a part for showing topic words that displays summaries of the document set correspondingly to multiple different viewpoints;
wherein the part for showing search result includes a part for selecting documents that selects the documents to become keys to a next search from a displayed document set,
the part for showing topic words includes a part for selecting topic words that selects the elements to become keys to a next search from elements of a displayed summary, and
the search client transmits a query inputted to the input part, or information of documents selected in the part for selecting documents or elements of a summary selected in the part for selecting topic words as a query.
